(19) United States
(12) Patent Application Publication
(10) Pub. No.: US 2014/0080566 A1
(43) Pub. Date: Mar. 20, 2014

(54) Game of Chance Allowing User Participation in Outcome Selection

(71) Applicant: John G. Lovell, SR., Knoxville, TN (US)

(72) Inventor: John G. Lovell, SR., Knoxville, TN (US)

(21) Appl. No.: 13/622,092

(22) Filed: Sep. 18, 2012

(51) Int. Cl. A63F 13/00; A63F 9/24

(52) U.S. Cl. 463/18; 273/139

(57) ABSTRACT

A game of chance is disclosed allowing an outcome determined by the actions of a player. The game of chance comprises a layout defining a plurality of cells. A first portion of the cells each have a winning indicia contained therein, and a remaining portion of the cells each have a non-winning indicia contained therein. The winning and non-winning indicia are initially concealed to a player and are selectively revealable by the player. The player may select a limited number of cells to reveal the indicia contained therein. An object of the game is to maximize a number of winning indicia revealed by the player.

### CROSS-REFERENCE TO RELATED APPLICATIONS

Not Applicable

### STATEMENT REGARDING FEDERALLY-SPONSORED RESEARCH OR DEVELOPMENT

Not Applicable

### BACKGROUND OF THE INVENTION

1. Field of Invention

The invention pertains to games of chance, and more particularly, to an improved game of chance that allows users to participate in selecting the outcome of the game.

2. Description of the Related Art

Games of chance involving one or more wagers on the outcome of a statistical event are generally known in the art. For example, in various lottery-type games of chance, a player typically pays an initial fee to participate in the game, whereupon lots are assigned among the various players of the game. Lots are then drawn to determine one or more winners, and each winner of the lottery game is typically rewarded with a prize, often a monetary amount equivalent to a portion of the proceeds from the initial fees. Assignment of lots in a lottery game is typically accomplished by assigning each player a number or other such designation, often printed on a card known as a “lottery ticket.”

Depending upon the specific lottery game being played, the lottery ticket and/or process of drawing lots to determine winners can take any of a number of forms. For example, in several lottery games, small cards known as “scratchcards” are used as lottery tickets. A scratchcard is a small card, often made of paper or plastic material, where one or more areas of the card contain concealed information which can be revealed by scratching off an opaque covering. In certain lottery games, an assigned lottery number is initially printed as concealed information on a scratchcard lottery ticket issued to the player, and the player reveals the concealed information in order to learn the assigned lottery number before lots are drawn to determine the lottery winner. In other lottery games, known as “instant win” games, the concealed information printed on a scratchcard lottery ticket, once revealed, immediately indicates whether the ticket is a winner. In each of these types of games, a significant drawback exists in that, once a player is assigned a scratchcard lottery ticket, the player has essentially no further input regarding the outcome of the lottery game, and must instead merely accept whatever information printed on the scratchcard assigned to the player. Thus, a player often feels as though they are not in control of the lottery game, and that the outcome of the game is instead determined solely by the actions of others, such as for example the distributor of the scratchcards.

In yet another lottery game, a scratchcard containing several areas of concealed information is issued to the player, and the player selects only a portion of the areas of concealed information on a given scratchcard to reveal. In this type of game, whether the player wins or not depends upon both the information printed on the card and the specific portions which are selected to be revealed. In the event a player reveals a losing combination of information, a player can then scratch off all areas of the scratchcard to see if, how, and what the player could have won with the particular card. This type of lottery game and the “instant win” lottery game described above are often popular due to the opportunity for a player to be determined as a winner immediately upon revealing the concealed information on the scratchcard, as opposed to waiting for a traditional drawing of lots. However, a significant drawback to these types of games lies in the fact that a player often does not know whether the particular scratchcard issued to the player is capable of winning before the player begins revealing the concealed information on the scratchcard. Thus, the player again feels as though the outcome of the game is determined, at least in part, by the assignor of the scratchcards, rather than by the actions of the player. Furthermore, this type of scratchcard game is vulnerable to tampering. For example, in the event a player is able to successfully scratch off the appropriate areas of a winning scratchcard such that the player wins the game, the winning scratchcard may nonetheless be voided through intentional or accidental scratching of additional areas.

In another game of chance, called “bingo,” each player is provided with a card that includes a matrix of five rows and five columns defining twenty-five grid squares. The left-most column is labeled “B”, the second column “I”, the third column “N”, the fourth column “G” and the right-most column “O”. Traditionally, each grid square, with the exception of the “free” center grid square, is labeled with a number in the range of 1 to 75. The grid squares in the “B” column use the numbers in the range of 1 to 15. The squares in the “I” column use the numbers in the range of 16 to 30. The grid squares in the “N” column, except the center square, use the numbers in the range of 31 to 45. The grid squares in the “G” column use the numbers in the range of 46 to 60. The grid squares in the “O” column use the numbers in the range of 61 to 75. Each grid square is defined by the combination of a letter identifying the column and a number. As a caller randomly calls combinations of columns and numbers, each player indicates which of that player's grid squares had been called, either through markings in the grid squares or by placing items on the squares. The first person to achieve a pre-determined pattern of called grid squares is the winner of that game. Examples of patterns include: one straight line, two straight lines; the entire card, the border of the grid, etc.

In the above-described game of bingo, each game card has the opportunity to be a winner, depending on the particular combinations of columns and numbers called by the caller. However, the player is typically not in control of the particular combinations of columns and numbers selected by the caller. Thus, as with the lottery games described above, the player often feels subjected to the actions of another, such as for example the caller of the combinations of columns and numbers, and therefore feels out of control of the outcome of the bingo game.

In games of chance in which a player feels that they are not in control of the outcome of the game, a player may often suspect that the outcome of the game has been unfairly manipulated, or that the game has been subjected to some other form of fraud, particularly if the player experiences multiple losses through repeatedly playing the same game. However, such suspicions of fraud in games of chance are much less likely if the player is made to feel in control of the game's outcome. Accordingly, there is a need for an improved game of chance, wherein the game involves player participation in selection of the game's outcome. Furthermore, there is a need for an improved game of chance which is less vulnerable to tampering than the above-discussed scratchcard games.

### BRIEF SUMMARY OF THE INVENTION

A game of chance having an outcome determined by the actions of a player is disclosed. In one embodiment, the present general inventive concept provides a game of chance comprising a layout defining a plurality of cells. A first portion of the cells each have a winning indicia contained therein, and a remaining portion of the cells each have a non-winning indicia contained therein. The winning and non-winning indicia are initially concealed to a player and are selectively revealable by the player. The player may select a limited number of cells to reveal indicia contained therein. An object of the game is to maximize a number of winning indicia revealed by the player. In certain embodiments, the game of chance includes a graphic interface on which the layout is displayed, and through which the player may interact with the game. The graphic interface may be provided, for example, by a personal computer with a video monitor display, a video arcade machine, a portable communication device having a touch-screen video display or other touch screen device, an electronic game board, or the like.

In several embodiments of the present general inventive concept, the layout defines a matrix of rows and columns. For example, in certain embodiments, the layout defines twenty-five cells arranged into five rows and five columns. In one embodiment, five of the cells contain winning indicia, and five of the twenty-five cells are selectable by the player to reveal.

In certain embodiments, the game of chance includes a wager element, whereby an initial wager is required to initiate the game of chance, and whereby a prize is awarded for selecting and revealing a threshold number of winning indicia. In certain embodiments, the value of the prize varies depending upon the number of winning indicia selected and revealed by the player. For example, in one embodiment, the prize value corresponding to the selection and revelation of two winning indicia is equivalent to the initial wager, the prize value corresponding to the selection and revelation of three winning indicia is equivalent to fifty times the wager, the prize value corresponding to the selection and revelation of four winning indicia is equivalent to five hundred times the initial wager, and the prize value corresponding to the selection and revelation of five winning indicia being equivalent to one thousand times the initial wager.

In certain embodiments of the present general inventive concept, a layout is provided defining twenty-five cells arranged into five rows and five columns, with each cell having one of a first indicia, a second indicia, a third indicia, a fourth indicia, and fifth indicia contained therein. For example, the first indicia could be a letter “B,” the second indicia could be a letter “I,” the third indicia could be a letter “N,” the fourth indicia could be a letter “G,” and the fifth indicia could be a letter “O.” The indicia are each initially concealed to a player and are selectively revealable by the player. During game play, the player selects five cells to reveal the indicia contained within said selected cells, and an object of said game is to achieve at least one specific combination of indicia revealed by the player. For example, in one embodiment, the combinations of indicia include a first combination comprising two of the first indicia (i.e., the word “B.B.”), a second combination comprising one of the first indicia, one of the second indicia, and one of the fourth indicia (i.e., the word “BIG”), a third combination comprising one of the first indicia, one of the fifth indicia, one of the third indicia, and one of the fourth indicia (i.e., the word “BONG”), and a fourth combination comprising one of each of the first, second, third, fourth, and fifth indicia (i.e., the word “BINGO”).

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a depiction of one embodiment of a layout of a game of chance constructed in accordance with several features of the present general inventive concept;

FIG. 2 is a depiction of a graphical user interface showing one embodiment of a game of chance constructed in accordance with several features of the present general inventive concept; and

FIG. 3 is a depiction of a graphical user interface showing another embodiment of a game of chance constructed in accordance with several features of the present general inventive concept;

FIG. 4 is a depiction of a graphical user interface showing another embodiment of a game of chance constructed in accordance with several features of the present general inventive concept;

FIG. 5 is a depiction of a graphical user interface showing another embodiment of a game of chance constructed in accordance with several features of the present general inventive concept;

FIG. 6 is a depiction of a graphical user interface showing another embodiment of a game of chance constructed in accordance with several features of the present general inventive concept;

FIG. 7 is a depiction of a graphical user interface showing another embodiment of a game of chance constructed in accordance with several features of the present general inventive concept.

### DETAILED DESCRIPTION OF THE INVENTION

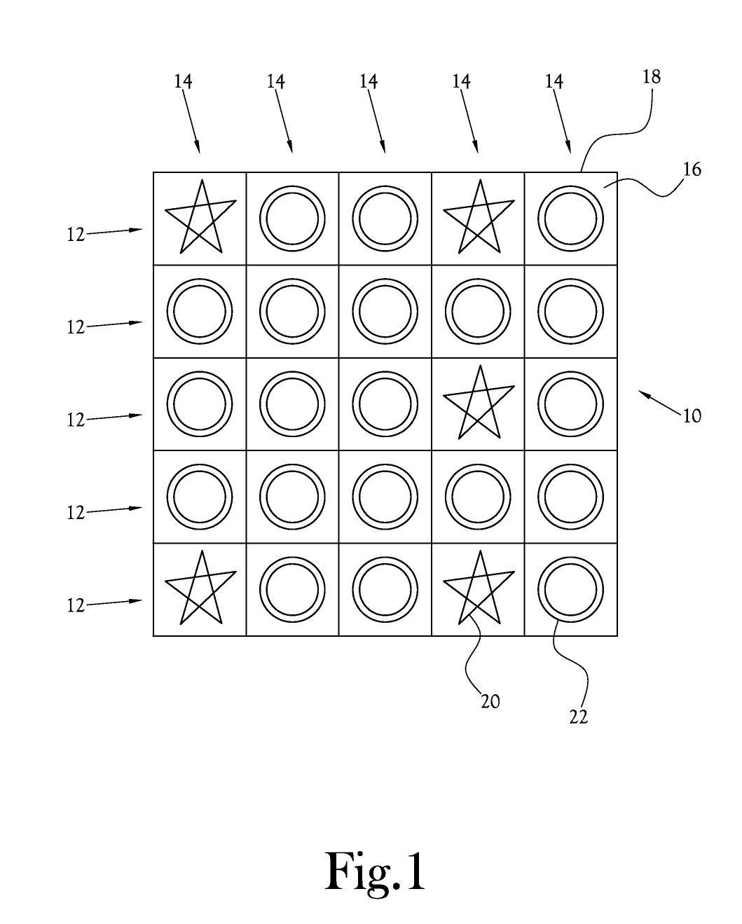

FIG. 1 illustrates one embodiment of a game of chance according to various features of the present general inventive concept. The game of chance, or game, is identified as 10 herein and in the accompanying figures. Referring to FIG. 1, in several embodiments, the game 10 is played using a layout 18 defining a plurality of cells 16 which, in several embodiments, are arranged into a grid of rows 12 and columns 14. Each cell 16 contains indicia indicating whether the cell is part of a winning combination of cells of the game 10. As will be further discussed hereinbelow, the indicia within each cell 16 is initially concealed from the player. As the game 10 proceeds, the player can select a certain number of cells from the entire group of cells 16, and the indicia within the selected cells is revealed to the player. If, after revealing the selected cells, a certain number and/or combination of winning indicia have been selected and revealed, the player wins the game 10. In certain embodiments, depending upon the specific number and/or combination of winning indicia exposed by the player, a prize is determined for a winning game 10.

In the embodiment of FIG. 1, the layout 18 includes twenty-five cells 16 arranged into a grid of five rows 12 and five columns 14. Five winning indicia 20 and twenty non-winning indica 22 are distributed at random locations with respect to one another among the cells 16, with one of the two types of indicia 20, 22 being contained within each cell 16. In the illustrated embodiment, the winning indicia 20 are each defined by an image of a star, while the non-winning indicia 22 are each defined by an image of a circle. However, it will be understood that numerous other indicia may be used to designate winning and non-winning indicia 20, 22 without departing from the spirit and scope of the present invention. Each of the indicia 20, 22 within each of the cells 16 is initially concealed from the player. As the game 10 proceeds, the player is given the opportunity to select five cells for which the indicia contained therein is revealed to the player. The object of the game 10 is for the player to maximize the number of cells 16 containing winning indicia 20 that are selected and revealed by the player. In various embodiments, in the event the player selects a threshold number of cells 16 containing winning indicia 20, the player wins the game 10.

It will be recognized by one of skill in the art that the above-described game 10 provides the unique advantage of allowing a player to participate in the outcome selection of the game 10, while also assuring the player that a winning outcome is possible for each iteration of the game 10. For example, in the above-described embodiment, a player is assured from the beginning of the game 10 that each particular layout 18 contains exactly five winning indicia 20 and twenty non-winning indicia 22 throughout the grid of cells 16. Thus, the only factors in determining the outcome of the game 10 are the particular distribution of winning indicia 20 throughout the cells 16 and the particular choices of the player in selecting which cells to reveal. Because the decisions of the player, rather than the actions of the organizer of the game 10, ultimately determine the outcome of the game 10, the player is therefore assured that the game 10 is being played fairly, and is not subjected to manipulation or fraud by the game's organizer.

In several embodiments, the game 10 includes a wager element. For example, in several embodiments, in order to initiate a game 10, a player must set forth an initial wager. In the illustrated embodiment of FIG. 1, the initial wager may be an amount of currency, such as for example $1.00, which must be paid to an organizer of the game 10 to allow the player to participate. Thereafter, in the event the player fails to select a sufficient number of cells 16 containing winning indicia 20, such that the player does not win the game 10, the wager amount is forfeited to the organizer. However, if the player selects a sufficient number of cells 16 containing winning indicia 20, such that the player wins the game 10, the player receives a prize, such as for example another amount of currency or other prize. In certain embodiments, the prize is valued greater than the initial wager. However, the prize may also be valued less than the initial wager, or may have no intrinsic monetary value, without departing from the spirit and scope of the present general inventive concept.

In certain embodiments, the game 10 includes a feature by which the prize grows depending upon the number and/or combination of cells 16 containing winning indicia 20 selected by the player. For example, in the embodiment of FIG. 1, the value of the prize awarded to the player varies depending upon the number of winning indicia 20 revealed by the player during the player's selection of cells. The values of the varying prizes are selected, at least in part, based on the probability that the player selects and reveals the particular cells necessary to produce the particular outcome of the game 10. In the illustrated embodiment, in the event the selection of five cells by the player reveals two winning indicia 20, the player receives an amount equal to the amount of the player's initial wager. In the event the selection of five cells by the player reveals three winning indicia 20, the player receives an amount equal to fifty-times the player's initial wager, which equals $50.00 for a $1.00 initial wager. In the event the selection of five cells by the player reveals four winning indicia 20, the player receives an amount equal to one-hundred-times the player's initial wager, which equals $500.00 for a $1.00 initial wager. In the event the selection of five cells by the player reveals five winning indicia 20, the player receives an amount equal to one-thousand-times the player's initial wager, which equals $1,000.00 for a $1.00 initial wager. In the event the selection of five cells by the player reveals one or zero winning indicia 20, the initial wager is forfeited by the player.

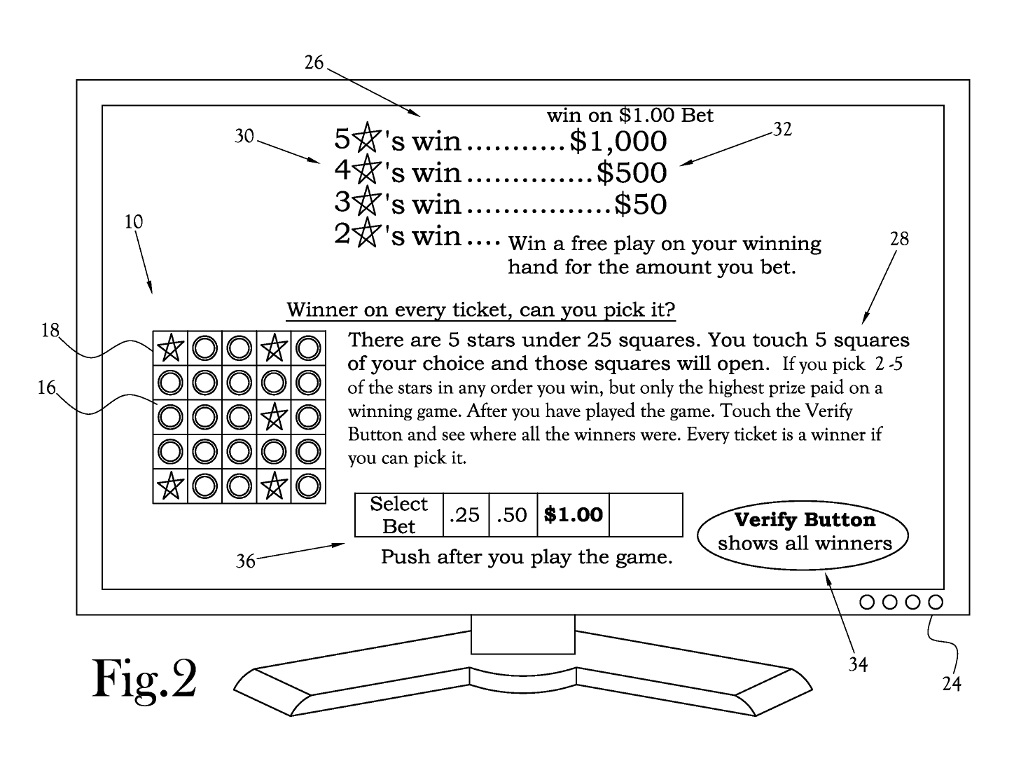

Referring to FIG. 2, in a preferred embodiment, the game 10 is implemented through the use of a computerized device which is in communication with a graphic interface 24. The graphic interface 24 is configured to display an image of the layout 18 and to cooperate with the computerized device to allow a player to make commands within the layout 18, for example to initiate a game, set forth an initial wager, select cells 16 to reveal, and collect prize awards. It will be understood that any of a variety of computerized devices and associated display devices, for example a personal computer with a video monitor display, a video arcade machine, a portable communication device having a touch-screen video display or other touch screen device, an electronic game board, etc., may be implemented using sound engineering judgment to produce an image of the layout 18 of the game 10 and to allow a user to interface with the game 10 as discussed above.

As shown in FIG. 2, in one embodiment of the present general inventive concept, a graphic interface 24 is provided which includes a plurality of video representations of various aspects of the game 10. For example, in the illustrated embodiment, an image of the layout 18 of the game 10 is provided, along with an instructional display 26 showing textual instructions 28 for how to play the game 10, the various possible winning combinations of indicia 30, and the available prizes 32 for each winning combination. The graphic interface 24 further includes a plurality of controls to allow a user to interact with the game 10. For example, a first series of controls are provided to allow a player to select which cells 16 the player wishes to reveal. In the illustrated embodiment, these first controls are overlaid with the various cells 16 of the layout 18, as by employing a touch-screen graphic interface 24 or other such device, such that a player may select which cells to reveal by engaging the cells themselves. In another embodiment (not shown), a separate series of buttons are provided to allow a user to designate particular cells 16 within the layout 18 to be revealed. A wager control 36 is also provided to allow the player to select and place an initial wager, thereby beginning a new game 10. In the illustrated embodiment, the wager control 36 is configured to allow a player to select an initial wager of $0.25, $0.50, $1.00, or $5.00 per game 10. However, those of skill in the art will recognize that other configurations for the wager control 36 may be used without departing from the present general inventive concept.

In the illustrated embodiment of FIG. 2, a verify game control 34 is provided. Upon accessing the verify game control 34, the game 10 is terminated, and all winning indicia 20 are revealed, thereby allowing the player to see the location of all winning indicia 20 in the layout 18. In certain embodiments, the verify game control 34 further serves to terminate a winning game 10, such that once a player reveals the allotted five cells 16, the verify game control 34 can be engaged to initiate the determination and/or awarding of prizes by the game 10. In other embodiments, the game 10 terminates automatically upon selection of the allotted number of cells 16 to be revealed by the player.

In certain embodiments, the programming governing the computer and graphic interface 24 implementing the game 10 is configured such that a player may not reveal a number of cells 16 greater than the number of cells containing winning indicia 20. For example, in one embodiment in which the above-discussed twenty-five cells 16 containing five winning indicia 20 and twenty non-winning indicia 22 are used, the computer and graphic interface 24 are configured such that, upon revealing five cells 16, the verify game control 34 is automatically engaged, such that the game 10 is terminated, and the results of the game 10 are determined. Thus, it will be recognized by one of skill in the art that implementation of the game 10 using the above-discussed graphic interface 24 provides the advantage of limiting intentional tampering of the game 10, such that a player or third party is prevented from voiding the game 10 by revealing additional cells 16 beyond the number of cells allowed to be revealed by the player during normal game play.

While the above-referenced embodiments have been described using an exemplary layout 18 including a grid of twenty five cells 16 having five winning indicia 20 and twenty non-winning indicia 22, it will be recognized by one of ordinary skill in the art that other designs and indicia may be used to accomplish the layout without departing from the spirit and scope of the present general inventive concept. In some embodiments, the layout may include greater or fewer cells. For example, in one embodiment, a layout is provided having thirty-six cells with six winning indicia and thirty non-winning indicia. In this embodiment, a player may select up to six cells to reveal the indicia therein. Prizes of varying value are provided for each outcome in which a player selects and reveals two or more winning indicia, with the values of the prizes for the varying outcomes being selected, at least in part, based on the statistical probability of the player selecting the cells necessary to produce the particular outcome.

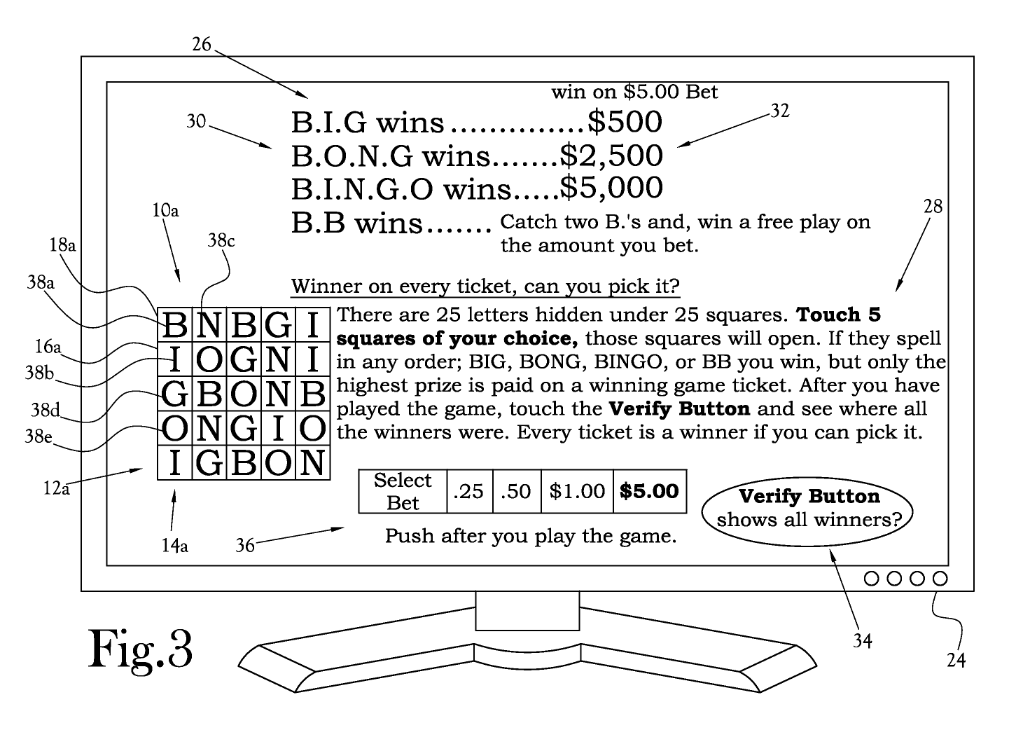

In other embodiments, rather than providing a layout 18 in which certain cells contain winning indicia 20 and other cells contain non-winning indicia 22, a layout is provided in which a variety of indicia are provided among the cells, and whether, and the degree to which, a player wins the game 10 depends upon the specific combination of different types of indicia revealed by the player. For example, FIG. 3 illustrates an alternate embodiment of the game 10a in which a layout 18a is provided having twenty-five cells 16a arranged into a grid of five rows 12a and five columns 14a. Each cell 16a contains one of five different indicia 38a-38e. In the illustrated embodiment, a first indicia 38a is defined by the letter “B,” a second indicia 38b is defined by the letter “I,” a third indicia 38c is defined by the letter “N,” a fourth indicia 38d is defined by the letter “G,” and a fifth indicia 38e is defined by the letter “O.” In this embodiment, the player is permitted to select and reveal the indicia in five of the cells, and the object of the game 10a is for the player to select and reveal a particular combination of indicia sufficient to allow the formation of one or more particular words from the revealed indicia. For example, in the event the selection of five cells by the player reveals two of the first indicia 38a, such that the word “B.B.” can be formed, the player is awarded a free play based on the initial wager amount, in other words, to repeat the game 10. In the event the selection of five cells by the player reveals one of the first indicia 38a, one of the second indicia 38b, and one of the fourth indicia 38d, such that the word “BIG” can be formed, the player receives an amount equal to fifty-times the player's initial wager. In the event the selection of five cells by the player reveals one of the first indicia 38a, one of the fifth indicia 38e, one of the third indicia 38c, and one of the fourth indicia 38d, such that the word “BONG” can be formed, the player receives an amount equal to five-hundred-times the player's initial wager. In the event the selection of five cells by the player reveals one of the first indicia 38a, one of the second indicia 38b, one of the third indicia 38c, one of the fourth indicia 38d, and one of the fifth indicia 38e, such that the word “BINGO” can be formed, the player receives an amount equal to one-thousand-times the player's initial wager. In the event the selection of five cells by the player reveals a combination of the various indicia through which none of the above-discussed words may be formed, the initial wager is forfeited by the player.

In certain embodiments of the present general inventive concept, the player is able to choose a symbolic designation for each of the five different indicia 38a-38e at the outset of the game 10. For example, in one embodiment, at the outset of the game 10, a player is presented with an option to choose symbols corresponding to the various indicia 38a-38e. The player may choose, for example, for the first indicia 38a to be a particular number, the second indicia 38b to be a particular letter, the third indicia 38c to be a particular symbol, and so forth. It will be understood that the player may choose for each of the indicia 38a-38e to be any of a number, a letter, a symbol, or the like. Furthermore, the player may choose, in certain embodiments, for the each of the indicia 38a-38e to be selected by a third party, such as for example the game organizer. Once the various indicia 38a-38e are selected, the various cells 16 are each designated with a particular selected indicia 38a-38e, and the game 10 proceeds as discussed above. It will be understood that the above-described selection by the player of symbolic designations for each of the five different indicia 38a-38e at the outset of the game 10 is not necessary to accomplish the present general inventive concept.

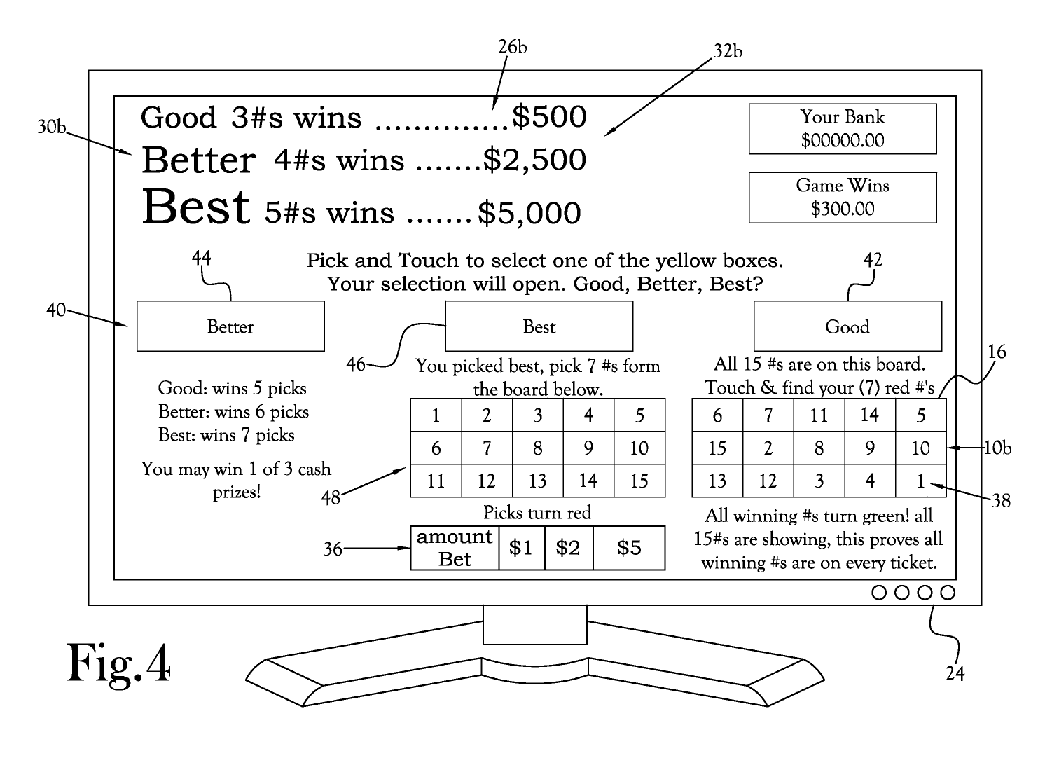

FIG. 4 illustrates another embodiment of the game 10b, displayed on a graphical user interface 26 as discussed above. In the embodiment of FIG. 4, each cell 16 of the game 10b contains a different indicia 38, such as for example sequential numbers, letters, etc. At the onset of the game 10b, an initial option 40 is presented to the player to allow the player to choose the number of indicia 38 in the game 10b to be designated as winning indicia. For example, in the illustrated embodiment, fifteen total cells 16 are provided, with sequential numerical indicia 38, numbers 1-15, contained in the cells 16. At the onset of the game 10b the player is presented with the initial option 40 in the form of three game controls, labeled “Good” 42, “Better” 44, and “Best” 46, respectively. In the event a player activates the “Good” control 42, the player is then able to access additional controls 48 to select five of the fifteen indicia 38 to be designated as winning indicia. In the event a player activates the “Better” control 44, the player is then able to access the additional controls 48 to select six of the fifteen indicia 38 to be designated as winning indicia. In the event a player activates the “Best” control 46, the player is then able to access the additional controls 48 to select seven of the fifteen indicia 38 to be designated as winning indicia. Once the winning indicia are selected, the player is then able to access the game layout 10b to select cells 16 for which to reveal the indicia 38 contained therein, with the object of the game being to maximize the number of winning indicia revealed.

Referring to the instructional display 26b of FIG. 4, in the illustrated embodiment, the various possible winning combinations of indicia 30b, and the available prizes 32b for each winning combination depend, at least in part, upon the number of winning indicia in the game 10b. For example, in the illustrated embodiment, if the player selects a wager amount 36 of $5.00, and if the “Good” game control 42 is selected, thereby invoking five winning indicia into the game 10b, a player must reveal at least three winning indicia through game play in order to win, with the available prize 32b for a winning game being $500.00. For the same selected wager amount, if the “Better” game control 44 is selected, thereby invoking six winning indicia into the game 10b, a player must reveal at least four winning indicia through game play in order to win, with the available prize 32b for a winning game being $2,500.00. For the same selected wager amount, if the “Best” game control 46 is selected, thereby invoking seven winning indicia into the game 10b, a player must reveal at least five winning indicia through game play in order to win, with the available prize 32b for a winning game being $5,000.00.

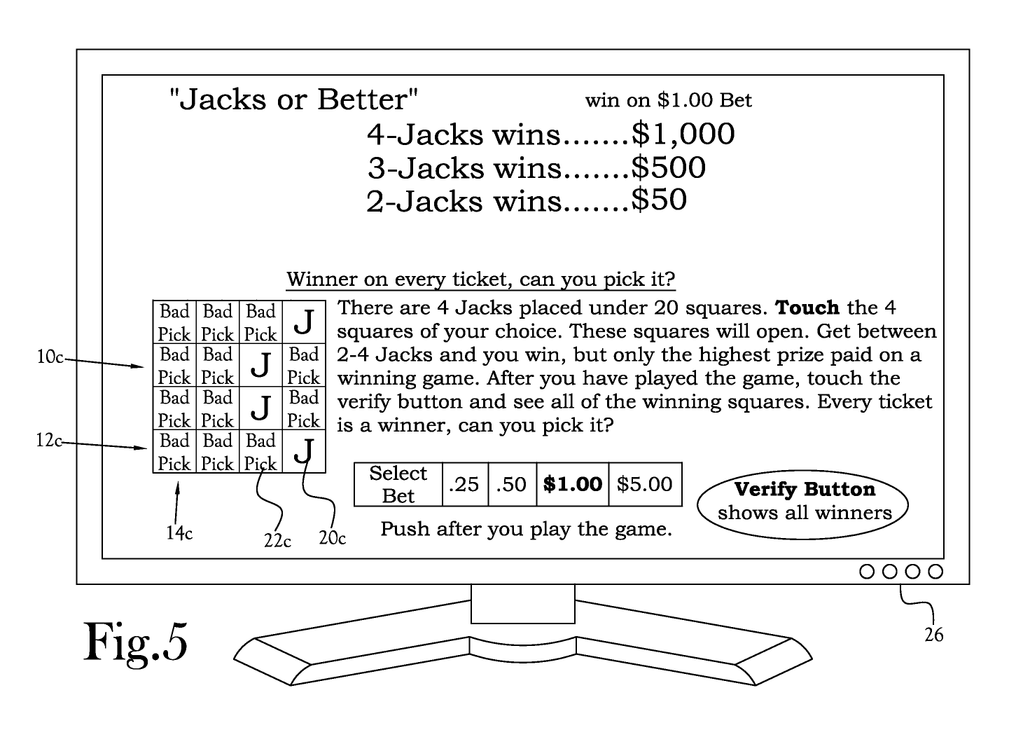

FIG. 5 illustrates another embodiment of the game 10c, displayed on a graphical user interface 24 as discussed above. In the embodiment of FIG. 5, sixteen cells 16 are provided, arranged into a grid of four rows 12c and four columns 14c. Four winning indicia 20c are provided, illustrated by a letter “J,” and twelve non-winning indicia 22c are provided, with one indicia 20c, 22c provided in each cell 16. In the illustrated embodiment, the player is given the opportunity to reveal four cells 16, and prizes are awarded for revealing at least two winning indicia 20c. For example, in the illustrated embodiment, for a selected wager of $1.00, the prize awarded for revealing two winning indicia 20c is $50.00, the prize awarded for revealing three winning indicia 20c is $500.00, and the prize awarded for revealing four winning indicia 20c is $1,000.00.

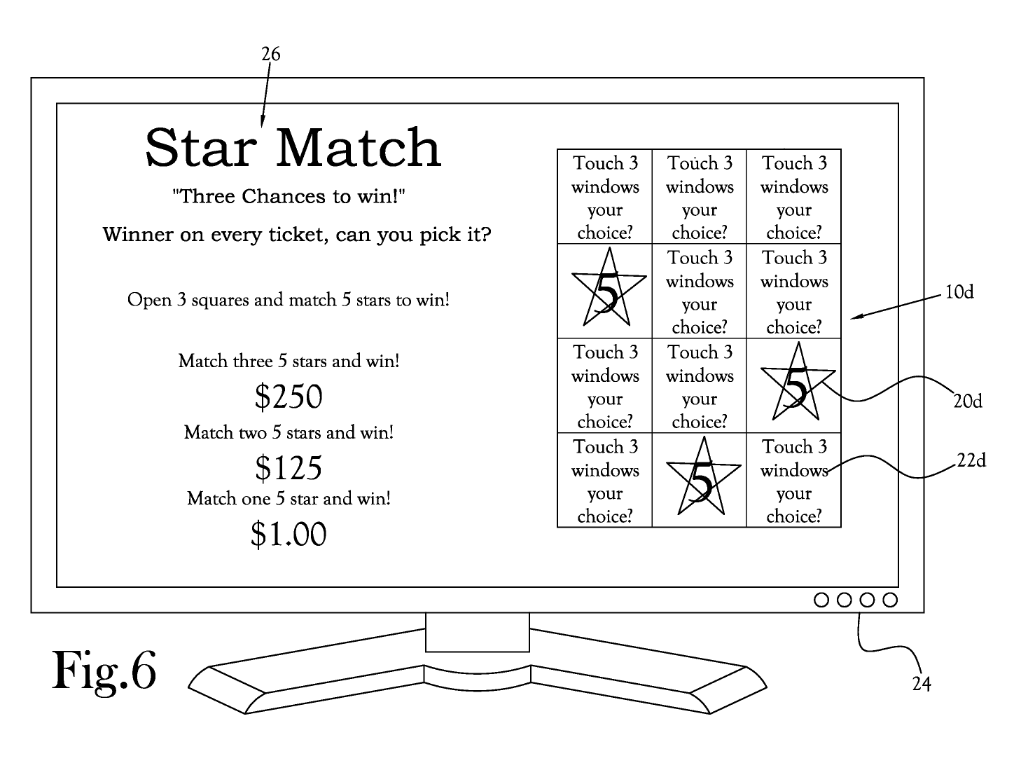

FIG. 6 illustrates another embodiment of the game 10d, displayed on a graphical user interface 24 as discussed above. In the embodiment of FIG. 6, twelve cells 16 are provided, with three winning indicia 20d and nine non-winning indicia 22d provided among the cells 16. In this embodiment, during game play, the player may reveal the contents of three cells 16. In the event the player reveals only one winning indicia 20d, a prize of $1.00 is awarded. In the event the player reveals only two winning indicia 20d, a prize of $125.00 is awarded. In the event the player reveals three winning indicia 20d, a prize of $250.00 is awarded.

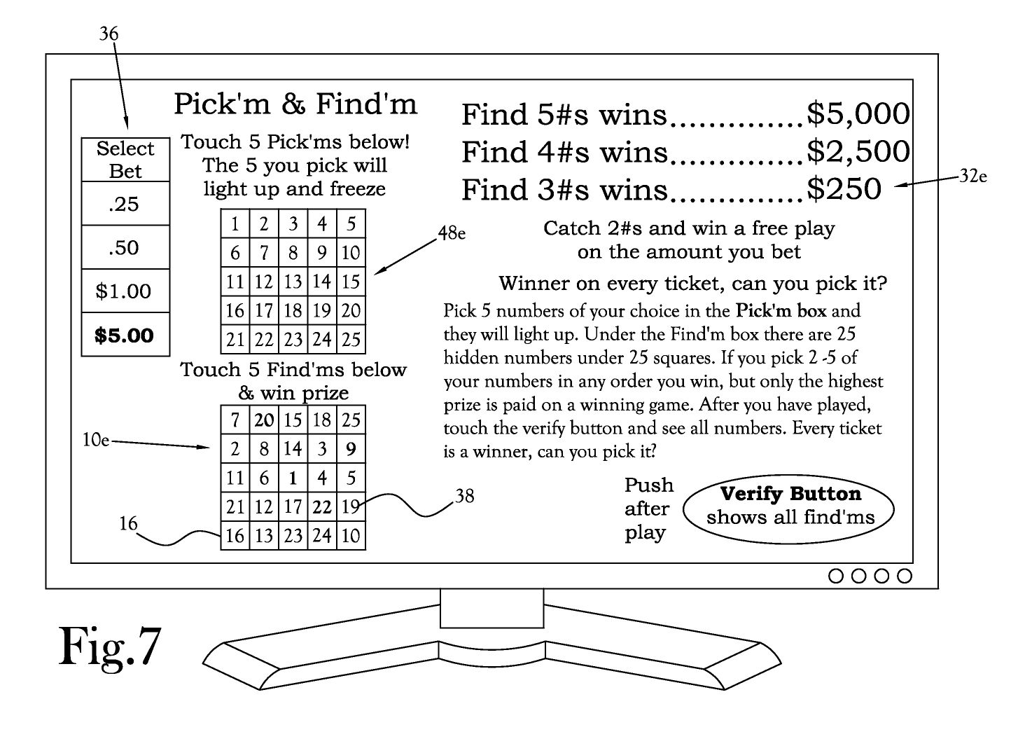

FIG. 7 illustrates another embodiment of the game 10e, displayed on a graphical user interface 24 as discussed above. In the embodiment of FIG. 7, twenty-five total cells 16 are provided, with sequential numerical indicia 38, numbers 1-25, contained in the cells 16. At the onset of the game 10e, the player is able to access controls 48e to select five of the twenty-five indicia 38 to be designated as winning indicia. Once the winning indicia are selected, the player is then able to access the game layout 10e to select cells 16 for which to reveal the indicia 38 contained therein, with the object of the game being to maximize the number of winning indicia revealed. In the illustrated embodiment, if the player selects a wager amount 36 of $5.00, and three winning indicia are revealed, the available prize 32e is $250.00. For the same selected wager amount, if four winning indicia are revealed, the available prize 32e is $2,500.00. For the same selected wager amount, if five winning indicia are revealed, the available prize 32e is $5,000.00.

While the present invention has been illustrated by description of several embodiments and while the illustrative embodiments have been described in detail, it is not the intention of the applicant to restrict or in any way limit the scope of the appended claims to such detail. Additional modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, what is claimed is:

1. A game of chance having an outcome determined by the actions of a player, said game of chance comprising:
a layout defining a plurality of cells, a first portion of said cells each having a winning indicia contained therein and a remaining portion of said cells each having a non-winning indicia contained therein, said winning and non-winning indicia being initially concealed to a player and selectively revealable by the player;
whereby the player may select a limited number of cells to reveal said indicia contained within said selected cells, an object of said game being to maximize a number of winning indicia revealed by the player.

2. The game of chance of claim 1, said layout being displayed on a graphic interface.

3. The game of chance of claim 2, said layout defining a matrix of rows and columns.

4. The game of chance of claim 3, said layout defining twenty-five cells arranged into five rows and five columns.

5. The game of chance of claim 4, said first portion of said cells being defined by five cells.

6. The game of chance of claim 5, said number of cells selectable by said player being five cells.

7. The game of chance of claim 6 further including a wager element, whereby an initial wager is required to initiate said game of chance, and whereby a prize is awarded for selecting and revealing a threshold number of winning indicia.

8. The game of chance of claim 7, whereby a value of said prize varies depending upon the number of winning indicia selected and revealed by the player.

9. The game of chance of claim 8, said prize value corresponding to the selection and revelation of two winning indicia being equivalent to said initial wager.

10. The game of chance of claim 9, said prize value corresponding to the selection and revelation of three winning indicia being equivalent to fifty times said initial wager.

11. The game of chance of claim 10, said prize value corresponding to the selection and revelation of four winning indicia being equivalent to five hundred times said initial wager.

12. The game of chance of claim 11, said prize value corresponding to the selection and revelation of five winning indicia being equivalent to one thousand times said initial wager.

13. A game of chance having an outcome determined by the actions of a player, said game of chance comprising:
a layout defining twenty-five cells arranged into five rows and five columns, each said cell having one of a first indicia, a second indicia, a third indicia, a fourth indicia, and fifth indicia contained therein, said indicia each being initially concealed to a player and selectively revealable by the player;
whereby the player may select five cells to reveal said indicia contained within said selected cells, an object of said game being to achieve at least one specific combination of indicia revealed by the player.

14. The game of chance of claim 13, said at least one combination of indicia including:
a first combination comprising two of said first indicia;
a second combination comprising one of said first indicia, one of said second indicia, and one of said fourth indicia;
a third combination comprising one of said first indicia, one of said fifth indicia, one of said third indicia, and one of said fourth indicia; and
a fourth combination comprising one of each of said first, second, third, fourth, and fifth indicia.

15. The game of chance of claim 14, said first indicia being a letter “B,” said second indicia being a letter “I,” said third indicia being a letter “N,” said fourth indicia being a letter “G,” and said fifth indicia being a letter “O.”

16. The game of chance of claim 15 further including a wager element, whereby an initial wager is required to initiate said game of chance, and whereby one of a plurality of prizes is awarded for selecting and revealing each specific combination of indicia.

17. The game of chance of claim 16, said prize value corresponding to the selection and revelation of said first combination being equivalent to said initial wager.

18. The game of chance of claim 17, said prize value corresponding to the selection and revelation of said second combination being equivalent to fifty times said initial wager.

19. The game of chance of claim 18, said prize value corresponding to the selection and revelation of said third combination being equivalent to five hundred times said initial wager.

20. The game of chance of claim 19, said prize value corresponding to the selection and revelation of said fourth combination being equivalent to one thousand times said initial wager.
